(19) United States
(12) Patent Application Publication
(10) Pub. No.: US 2023/0155256 A1
(43) Pub. Date: May 18, 2023

(54) ENERGY MODULE

(71) Applicant: TVS MOTOR COMPANY LIMITED, Chennai (IN)

(72) Inventors: Rameshwar Parate Tushar, Chennai (IN); Pramila Rao Nileshwar, Chennai (IN); Jabez Dhinagar Samraj, Chennai (IN)

(73) Assignee: TVS MOTOR COMPANY LIMITED, Chennai (IN)

(21) Appl. No.: 17/919,357

(22) PCT Filed: Apr. 17, 2021
(86) PCT No.: PCT/IN2021/050381

§ 371 Date: Oct. 17, 2022

(30) Foreign Application Priority Data
Apr. 17, 2020 (IN) 202041016680

(51) Int. Cl. H01M 50/517; H01M 50/213; H01M 50/507; H01M 50/383; H01M 50/242; H01M 50/271; H01M 50/30

(52) U.S. Cl. CPC H01M 50/517; H01M 50/213; H01M 50/507; H01M 50/383; H01M 50/242; H01M 50/271; H01M 50/394

(57) ABSTRACT

An energy module for a powered unit includes: a plurality of cells; a pair of current collector strips; and a plurality of rivets. The plurality of rivets are configured to electrically connect the plurality of cells to the pair of current collector strips. Each cell of the plurality of cells consists of two terminals. The pair of current collector strips are mounted on the two terminals of each cell of the plurality of cells using the plurality of rivets. An elastic member based electrical connector assembly, along with a rivet from the plurality of rivets, is connected to at least one terminal of each cell of the plurality of cells for establishing an electrical connection between the at least one terminal and a current collector strip from the pair of current collector strips.

### TECHNICAL FIELD

The present subject matter relates to the energy module. More particularly, the present subject matter relates to the energy module in which a plurality of unit cells is stacked.

### BACKGROUND

Basically, the rechargeable batteries can be charged or discharged unlike the primary batteries which are not capable of getting recharged. Generally, the low capacity battery where only one battery is packaged into a pack shape may be used as the power source for the various compact and portable electronic devices like the mobile phones etc. In case of high capacity battery in which several number of batteries are connected in series or parallel, the high capacity battery may be used for powered devices e.g. power banks, laptops or driving motors such as electric scooters, hybrid vehicle etc.

A battery is proposed as a clean, efficient and environmentally responsible power source for powered devices like electric vehicles and various other applications, where one type of battery is lithium ion battery which is rechargeable and can be formed into a wide variety of the shapes and sizes so that the space available in the electric vehicle is efficiently filled. A combination of plurality of lithium ion battery cells can be provided in a battery cell module to provide or generate the amount of power sufficient to operate a powered unit & especially a portable powered device.

Generally, a conventional energy module includes a plurality of battery cells arranged in a stacked configuration and also is in electrical communication with an electrical device. Further, each of the battery cells includes a cathode and anode terminals where the terminals are electrically connected in a combination of series & parallel configuration in order to maximize the voltage output & running time of the energy module. In certain designs, a battery cover has to be disposed over the stack of the battery cells to isolate and protect the anode and cathode terminals of each of the cells.

### BRIEF DESCRIPTION OF THE DRAWINGS

The detailed description is described with reference to the accompanying figures. The same numbers are used throughout the drawings to reference like features and components.

FIG. 1 is perspective view of energy module as per one embodiment of the present invention.

FIG. 1a is an exploded view of energy module as per one embodiment of the present invention.

FIG. 2 is a sectional view of plurality of Li ion cylindrical cell as per one embodiment of the present invention.

FIG. 3 is the sectional view of the rivet for terminal B of Li ion cylindrical cell as per one embodiment of the present invention.

FIG. 3a is an exploded view of the elastic member based electrical connector system as per one embodiment of the present invention.

FIG. 4 is the sectional view of the rivet for terminal B of the Li ion cylindrical cell as per one embodiment of the present invention.

FIG. 5 is an exploded view of cell holder casing as per another embodiment of the present invention.

### DETAILED DESCRIPTION

The battery industry in continually expanding to meet the increasing energy needs of the portable equipment, transportation and communication markets. Lithium ion based energy devices are becoming the industry standard battery due to its high energy density, sealed design and high availability in the world market.

Generally, batteries are classified into primary and secondary batteries, where the primary batteries are also referred as the disposable batteries and mostly intended to be used until exhausted after which the battery is simply replaced by one or more batteries. Secondary batteries, commonly referred as rechargeable batteries can be repeatedly recharged and reused, thus are economical in the long run, environmental as compared to disposable batteries.

While rechargeable batteries offer many advantages over primary batteries but also has some drawbacks which are based on the chemistry of the battery used, as these chemistries of the secondary cell is less stable as compared to the primary cell. Further, due to these relatively unstable chemistries, special handling of the secondary cell is often required during manufacture.

A lithium ion battery is typically configured as a secondary battery (rechargeable battery), which mainly depends on lithium ions (Li+) moving between a positive electrode and a negative electrode to work. During charging and discharging, Li+is embedded and travels between two electrodes; Li+is withdrawn from the positive electrode, and the electrolyte is embedded in the negative electrode. Therefore, the negative electrode is in a lithium-rich state. When charging, the lithium ion battery generally uses a material containing lithium as an electrode, which is representative of modern high-performance batteries.

Further, the Li ion batteries are produced in a number of variations; the most popular Li ion batteries, having the highest energy density, use a cobalt or nickel cobalt oxide anode. These batteries also have the disadvantage like when overheated; they tend to create their own internal supply of oxygen. More particularly oxygen is released from the oxide material of the anode at high temperature, which occurs due to many reasons like internal short circuit, overcharging, or any other causes. Since both oxygen and fuel are internally available to the cells, a fire can start within a single cell and can be difficult to extinguish with conventional methods potentially leading to safety risks.

Moreover, the secondary battery such as lithium ion batteries tend to be more vulnerable to the thermal runaway than primary batteries and the main reason for occurrence of the thermal runaway is when the internal reaction rate increases to the point where the heat generation rate is more than the rate at which it is removed. Moreover, both the reaction rate and the exothermic reaction further increases. As a consequence, the calorific value generated in the energy device will be high enough to cause combustion of the battery and materials in close vicinity to the battery. The main reasons for thermal runaway are shorting within the cell, improper use of the cell, physical abuse, manufacturing defects or exposing the cell to excessive external temperatures.

Thermal runaway is an important issue because a single event of thermal runaway can cause serious physical harm\damage and in some case, it can cause harm to the human body or loss of life. When a battery is in thermal runaway condition, the battery generally emits a large amount of smoke, a jet of burning liquid electrolyte and significant heat, which results into the burning and destruction of the surrounding components nearby to the battery. Also, if the battery pack is having a stack of the cells, a single thermal runaway event will instantly cause thermal runaway of the multiple cells, hence, potentially causing extensive damage to the stack of the cells and its surrounding components. Further, the flame generated due to thermal runaway condition, also contributes in the increase of effect of property damage if the initial flame is not instantly extinguished, irrespective of the energy device consisting of single cell or the multiple cell.

Taking example of the thermal runaway in the laptop or electric vehicle, the thermal runaway in the laptop without any human attachment can cause not only damage to the laptop but also, at least some damage to the surrounding near to the laptop like as home, offices, cars etc. Furthermore, worst situation can occur if the laptop battery is mounted on the board of aircraft, the resulting smoke due to thermal runaway can cause a fatal crash landing or an emergency landing in more demanding situations. Similarly, taking the example of the electric vehicle, the thermal runaway of one or more batteries in the battery pack of a hybrid or electric vehicle not only damages the vehicle but also can cause accident and damage to the environments surrounding the components of the vehicles. Further, to overcome the thermal runaway effect, valves are used to vent gas from cells but the problem arises when one needs to vent gases from a pack of cells configured together to form an energy module & there is need to vent gases from the energy Module by controlled venting such that the enclosed energy module gas pressure is maintained within target limit for safe working of the energy module. Also, in known art, to overcome the thermal runaway, the Li ion cylindrical cells are connected to a common current collector strips by spot welding. Further, this procedure requires high precision as it may damage the cell terminal and also, rectifying an error in the single cell will not be possible eventually it may lead to discarding of whole energy module which is undesirable. Further, another method which has been taken up in known art is cell terminals fixed in cell holder assembly. The cell terminals are in contact with current strip via a rivet type electric joint. Further, here since both the terminals are lookalike during manufacturing and in production line there is a possibility of terminal getting exchanged or mixed-up. Additionally, the shock created due to thermal runaway will not be absorbed by the cell as shock absorbing capabilities of the rivets are less. This situation arises because the space for venting out the gases during thermal runaway from the energy module is hampered The space constraints as both sides of the cell becomes rigid or reduced due to the presence of rivet which eventually can damage the cells. The space constraints due to the presence of rivet may also lead to propagation of fire, both of which are undesirable. Thus there is a need for an improved & efficient energy module or an energy device which overcomes all the above problems & other problems of known art.

Hence, there exists a challenge of designing an efficient energy module with the electric connector rivet, which can satisfactorily accommodate the Li ion cylindrical cells without any major change in design and manufacturing set-up of a static powered device or a mobile powered unit.

Therefore, there is a need to have an improved energy module which overcomes all of the above problems and other problems known in the art.

The present invention provides a solution to the above problems while meeting the requirements of minimum modifications in the powered unit at low cost with ease of manufacturing etc.

With the above objectives in view, the present invention relates to the energy module and more particularly to the improved mounting of energy module where the one or more terminals in the cell is connected to the current collector strip and also, on at least one terminal of the cell, elastic member based electrical connector system is connected with the rivet to vent out the undesirable gases from each cell from the energy module where the energy module is consisting of a plurality of cells & inbuilt valve to vent out undesirable gas for each individual cell, thereby, making it safe, secure, and also, increasing the ease of assembly.

As per one aspect of the present invention, the energy module consist of the Li ion cylindrical cells (referred as cells) connected either in series or parallel arranged in a cell holder casing and covered with an external cover. Further, as per one aspect of the present invention, the cell holder casing of the energy module includes slots which accommodate the stack of cells (battery) inside it and also, as per one aspect of present invention, the cell holder casing when viewed from back side, has rib type projection which provides strength to the energy module. Further, as per one aspect of the present invention, the cell holder casing of the energy module includes two portions; top and bottom; where both the portions have holes to assemble current collector strip with the rivet, ensuring rigid mounting of the current collector strip on the cell holder casing. Further, as per one aspect of the present invention, the external cover of an energy module which is sliding in nature includes the holes to dissipate the heat from the Li ion cells by the conductive cooling.

As per one aspect of the present invention, the energy module consists of the plurality of the Li ion cylindrical cells with current collector strips where the plurality of the Li ion cylindrical cell have two ends (terminal A and terminal B), where the plurality of elastic member based electrical connector system is connected to the at least one terminal of cell with a rivet, which ensures the correct assembly of the multiple cells in the module by the operators in the assembly line and also restrict the faulty assembly in form of reversing of terminal of cells . Further, as per one aspect of the present invention, the remaining opposite terminal of the cell is connected to current collector strip with a rivet and each pair of current collector strips are connected with the rectangular shaped connector strip, ensuring the connection of the of cells either is series or parallel.

Further, as per another aspect of the present invention, a protective shield having thermal insulation and fire-retardant property is incorporated between cell holder casing and external cover of the cell holder casing which prevents the heat and flame propagation in case of fire due to thermal runaway effect in the cell. Further, this protective shield can be incorporated between the cells, which will increase the protection of the cells.

As per one aspect of the present invention, the elastic member based electrical connector system includes three parts that is upper ring, middle coil and lower disc. The upper ring is connected to at least one terminal of the cell. Middle coil acts as a shock absorber where the middle coil absorbs the shock occurring in cell due to thermal runaway effect. The lower disc connects with the current collector strips with the rivet, which protects the cell during thermal runaway effect. During thermal runaway, valve inside the cells open up and release gases from the cell terminal and, hence, the particular terminal where the elastic based electrical connector is mounted, can get compressed allowing the easy opening of valve and further, the gases are released into the atmosphere through the holes in the external cover and rivet, thereby, ensuring the complete venting of gases from the energy module.

Further, as per one aspect of the present invention, the upper ring is made up of positive temperature coefficient material which prevents current flow when the cell temperature is above the threshold point. Further, this mechanism helps in disconnecting cell electrically in case of failure leading to increase in temperature above safety limit.

Further, as per another aspect of the present invention, a cell holder casing for stack of li ion cylindrical cell is split type where the stack of cell is placed in separate compartment. As per another aspect of the present invention, the stack of cell is cover by a covering member having openings. The covering member is sliding in nature includes the openings to dissipate the heat from the plurality of Li ion cells by the conductive cooling.

In the ensuing exemplary aspects, stack of cell is Li ion cylindrical cells. However, it is contemplated that the concepts of the present invention may be applied to any of the other high-density ion technology (having opposite terminals) which may also be vulnerable to explosion & fire hazard without defeating the spirit of the invention

Various other features of the invention are described in detail below with reference to the accompanying drawings. In the drawings, like reference numbers generally indicate identical, functionally similar, and/or structurally similar elements. The drawing in which an element first appears is indicated by the leftmost digit(s) in the corresponding reference number. With reference to the accompanying drawings, wherein the same reference numerals will be used to identify the same or similar elements throughout the several views. Further, the present subject matter can be implemented on both the terminals of cylindrical cells.

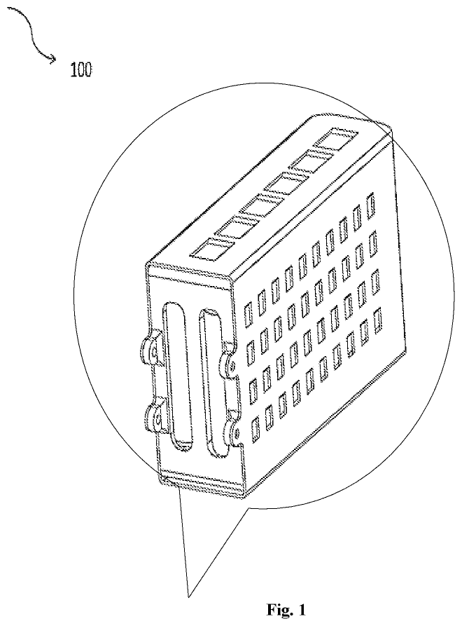

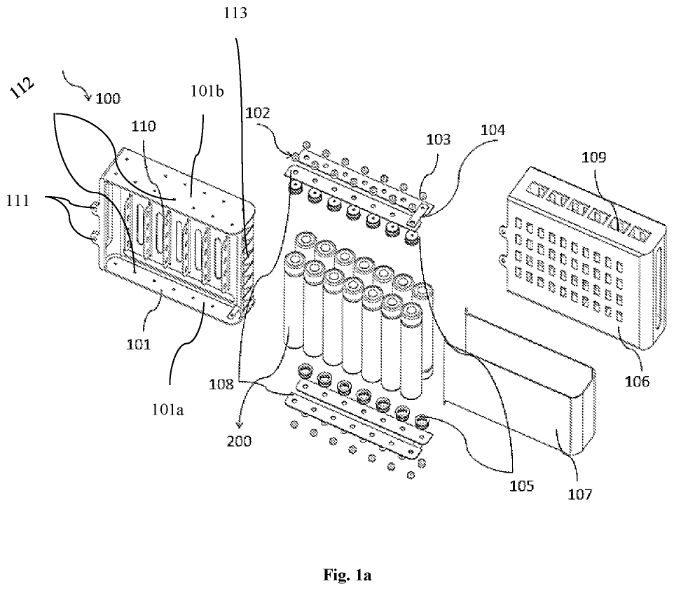

FIG. 1 shows the perspective & FIG. 1a shows an exploded view of the energy module. As per one embodiment of the present invention, the energy module (100) consist of the plurality of Li ion cylindrical cells (200) (as shown in fig. la) connected either in series or parallel arranged in a cell holder casing (101) and covered with an external cover (106). Further, as per one embodiment of the present invention, the cell holder casing (101) of the energy module (100) includes divided slots (110) which accommodate the stack of cells (battery) (200) inside it. Further, as per one embodiment of present invention, the cell holder casing (101) when viewed from back side, have rib type projection (113) which provides rigid placement to the energy module inside the cell holder casing. The cell holder casing has projection (111) with holes to detachably attach the cell holder casing (101) with external cover (106). Further, as per one embodiment of the present invention, the cell holder casing (101) of the energy module (100) includes two portions, top (101a) and bottom (101b) where both the portions have holes (112) to assemble current collector strip (also called as interconnector) with the rivet, ensuring a rigid mounting of the current collector strip (108) on the cell holder casing (101). Further, as per one embodiment of the present invention, the external cover (106) of an energy module which is sliding in nature includes the openings (109) to dissipate the heat from the plurality of Li ion cells by the conductive cooling.

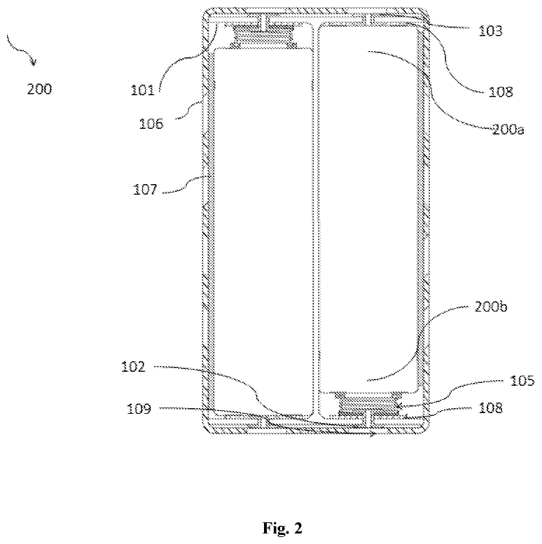

The cell holder casing (101) consists of the plurality of the Li ion cells (200) with current collector strips (108) where the plurality of the Li ion cell have two terminals (terminal A and terminal B) (200a, 200b) (as shown in FIG. 2), where the plurality of elastic member based electrical connector system (105) is connected to at least one terminal (terminal B) (200b) of cell with a rivet (102), which ensures the correct assembly of the multiple cells in the module by the operators in the assembly line and also avoids any faulty assembly in terms of reverse terminal of cells,. This potentially saves the assembly time as well as is cost effective. Further, as per another embodiment of the present invention, the elastic member based electrical connector system (105) can be connected to the terminal A (200a) of the cell and also, each pair of current collector strips (108) are connected with the rectangular shaped connector strip (104), ensuring the connection of the cells either is series or parallel.

Further, as per one embodiment of the present invention, a protective shield (107) having thermal insulation and fire-retardant property is incorporated between cell holder casing (101) and external cover (106) of the energy module (100) which prevents the heat and flame propagation in case of fire due to thermal runaway effect in the cell. Further, this protective shield (107) can be incorporated slidable to at least one side of the plurality cells (200), which increases the protection of the cells. The cell holder casing and the external cover are made up of electrical insulating materials, for example, plastic/polymer etc.

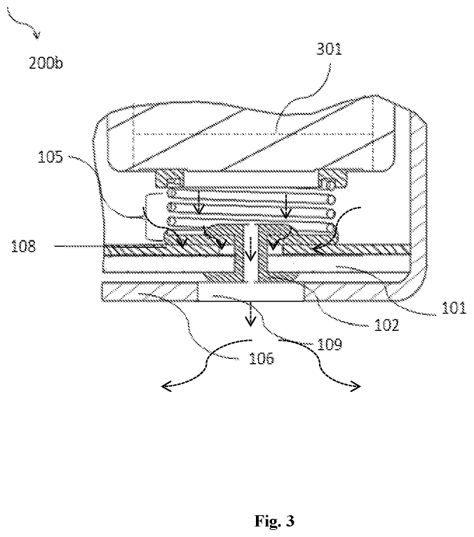

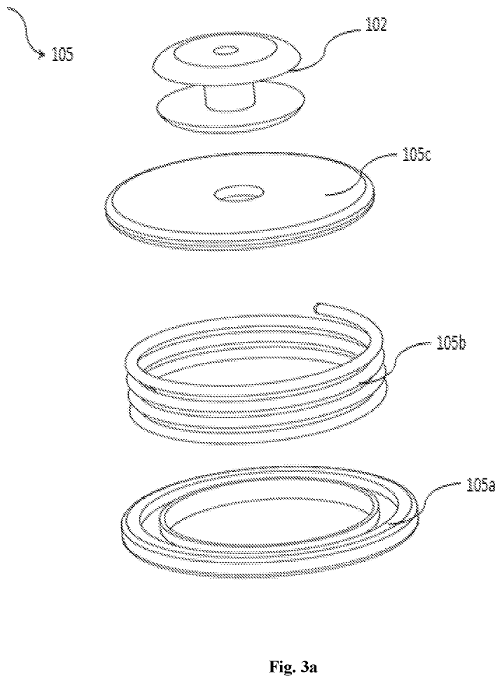

FIG. 3 is the sectional view of the rivet for terminal B of the plurality of Li ion cell. As per one embodiment of the present invention, the elastic member based electrical connector system is detachably attached to the terminal B (200b) of the cylindrical cell (200) with the rivet (102). Further, the elastic member based electrical connector (105) includes three parts (as shown in FIG. 3a) that are upper ring (105a), middle coil (105b) and lower disc (105c) where the upper ring (105a) is connected to the terminal B (200b) of the cylindrical cell, middle coil (105b) acts like a shock absorber and also, ensure ease of assembly, further, lower disc (105c) establishes the connection with the current collector strips (108) through the rivet (102), where the rivet has hollow portions in top and bottom surface. The lower disc (105c) is made up of positive temperature coefficient material and middle coil (105b) is made up of materials having high electric conductivity like copper, brass etc. Further, the upper ring (105a) is made up of positive temperature coefficient material, whose electrical resistance increases when its temperature increases and the higher the coefficient, the greater an increase in electrical resistance for a given temperature increase, which ensure the restriction of flow of current when the temperature of the cell is above threshold point. This eventually disconnects cell electrically in case of failure owing to increase in temperature above safety limit. Also, presence of the elastic based electrical connector system on at least one terminal of the cell basically increases the ease of assembly for the operators in production line as it makes the identification of the terminals of the cell easy during assembling of multiple cells in the energy module. Further, when the gases in the cell gets accumulated due to thermal runaway and the valve (301) inside the cell opens up for releasing the gases, the spring present on the elastic member based electrical connector system compresses itself allowing valve of the cell to be opened up easily. The easy opening of the valve because of the compressing of the spring, thereby leads to venting out the gases through the terminal of the cell (shown in FIG. 3 through arrow lines) & ensures the presence of enough space in the cell to vent out the gases and hence, protecting the surrounding components of the energy module.

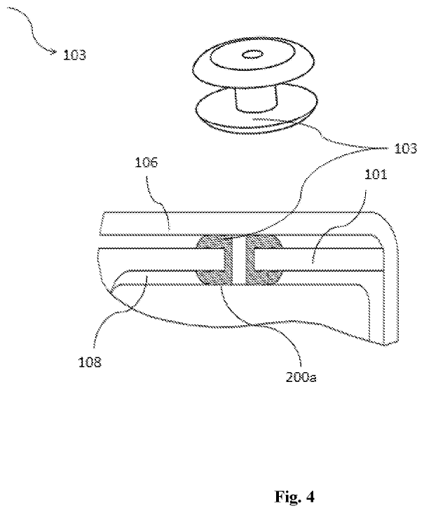

FIG. 4 is the sectional view of the rivet for terminal A of the plurality of Li ion cell. As per one embodiment of the present invention, the terminal A (200a) of cell is connected to current collector strip (108) with a rivet (103) where the rivet has hollow portions in top and bottom surface. During thermal runaway condition, the gases generated during the operation of the cell or combustion in the cell, are vented out through the holes of the rivet (102) from another terminal i.e. here for reference terminal B, as the elastic member based electrical connector system is compressed because of the presence of elastic member, for example spring, hence, the valve inside the cell is easily opened and vent out the undesirable gas. Further, the gas is released out from the cell through the opening (109) present on the external cover (106) of the energy module (100), thereby reducing the chances of cell explosion and increasing the safety measure of the energy module. The rivet (102) for terminal B and rivet (103) for terminal A are made up of materials having high electric conductivity, for example, copper, brass etc.

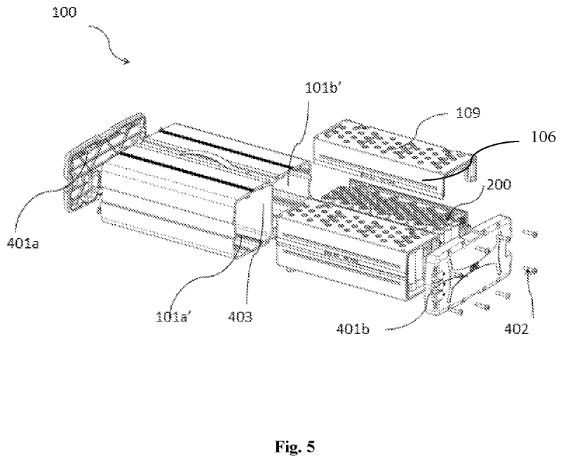

FIG. 5 is an exploded view of split type cell holder casing as per another embodiment of the present invention. As per another embodiment of the present invention, a cell holder casing (100) includes separate compartments (101a′, 101b′) where at least a stack of cell (200) is placed. The at least stack of cell (200) is covered by a covering member (106) having opening (109), ensuring to dissipate the heat from the plurality of Li ion cells by the conductive cooling. The cell holder casing (100) is covered from front and rear direction with a pair of end cover (401a, 401b). The pair of end cover (401a, 401b) is detachably attached to cell holder casing (100) with various attachment means, for example: fasteners (402), ensuring that the stack of cell is placed securely inside the cell casing holder. The stack of cell (200) as placed in the separate compartments (101a′, 101b′) is having a control algorithm, to operate single pack or both together at a time with an individual BMS. Further, pair of switches is integrated in corresponding BMS circuit boards. When both the BMS circuit board is working correctly, the switches are closed, but when one of the BMS circuit board is not working, the corresponding switch is open and non-functional stack of cell is isolated. The connection is established with the copper connectors moulded in the end cover (401a, 401b), thus eliminating the need of external wire connection and routing. As per another embodiment of the present invention, the cell holder casing (100) is separated by an aluminum extrusion (403), which protects the stack of cell placed in another compartment, in case of fire or thermal issues with one of the stack of cell placed in one compartment. The invention helps in overcoming the problem of space constraints, minimizing the use of new components, increasing the ease of accessibility of the cylindrical cell of the energy module while ensuring the safety of the surrounding components of the energy module.

Advantageously, the embodiments of the present invention, describes the potential modifications in the assembly of the elastic member based electrical connector system to the terminal B of the cell. This facilitates the simple and easy releasing of gases accumulated during the thermal runaway condition in the cell which efficiently increases the ease of accessibility and safety of the surrounding components of the energy module.

Many other improvements and modifications like using different elastic means having stiffness may be incorporated herein without deviating from the scope of the invention.

### LIST OF REFERENCE SYMBOL:

FIG. 1:
100: Energy Module
101: Cell holder casing
101a: Top Portion
101b: Bottom Portion
106: External Cover
110: Slots
113: Rib type projection
111: Projection with slots
112: Holes
108: Current Collector Strip
109: Holes (External Cover)
102: Rivet (Terminal B)
103: Rivet (Terminal A)
104: Connector Strip
107: Protective shield
105: Elastic member based electrical connector system
200: Li ion cylindrical cells.
FIG. 2:
200a: Terminal A
200b: Terminal B
FIG. 3
105a: Upper Ring
105b: Middle coil
105c: Lower Disc
FIG. 5.
401a, 401b: Pair of end covers
402: Fasteners
403: Aluminium Extrusion
101a′, 101b′: Separate Compartment

1.-11. (canceled)

12. An energy module for a powered unit, comprising:
a plurality of cells;
a pair of current collector strips; and
a plurality of rivets,
wherein
the plurality of rivets are configured to electrically connect the plurality of cells to the pair of current collector strips;
each cell of the plurality of cells consists of two terminals;
the pair of current collector strips are mounted on the two terminals of each cell of the plurality of cells using the plurality of rivets; and
an elastic member based electrical connector assembly, along with a rivet from the plurality of rivets, is connected to at least one terminal of each cell of the plurality of cells for establishing an electrical connection between the at least one terminal and a current collector strip from the pair of current collector strips.

13. The energy module as claimed in claim 12, wherein the elastic member based electrical connector assembly comprises:
an upper ring configured to be connected to the at least one terminal of each cell of the plurality of cells,
a middle coil positioned between the upper ring and a lower disc, and
the lower disc structurally connected with the middle coil;
wherein
the lower disc connects to the current collector strip with a rivet out of the plurality of rivets, and
the lower disc is made of positive temperature coefficient material.

14. The energy module as claimed in claim 12, wherein the at least one terminal is connected to the current collector strip with a rivet out of the plurality of rivets.

15. The energy module as claimed in claim 12, wherein the plurality of cells are covered with a protective shield, the protective shield being mounted between a cell holder casing and an external cover of the energy module.

16. The energy module as claimed in claim 15, wherein the protective shield is slidable from at least one side of the plurality of cells.

17. The energy module as claimed in claim 15, wherein the cell holder casing is configured with slots to accommodate a stack of cells from the plurality of cells in separate compartments.

18. The energy module as claimed in claim 15, wherein the cell holder casing has a top portion and a bottom portion, the top portion and the bottom portion are configured with one or more holes to attach the current collector strip with the rivet.

19. The energy module as claimed in claim 13, wherein the middle coil is configured to act as a shock absorber for shock occurring in each cell of the plurality of cells due to thermal runaway effect.

20. The energy module as claimed in claim 17, wherein the stack of cells are placed in each of the separate compartments operate as a battery pack.

21. The energy module as claimed in claim 20, wherein the cell holder casing is covered by a pair of end covers with various attachment means.

22. The energy module as claimed in claim 15, wherein the external cover comprises one or more venting holes and each cell of the plurality of cells release gases through a venting path created between the rivet from the plurality of rivets and the one or more venting holes, on compression of a middle coil of the elastic member based electrical connector assembly.
